(19) United States
(12) Patent Application Publication
(10) Pub. No.: US 2026/0335861 A1
(43) Pub. Date: Oct. 29, 2026

(54) POROUS ADSORBENT MATERIAL FOR GASEOUS POLLUTANTS

(71) Applicant: ADSORBI AB, GÖTEBORG (SE)

(72) Inventors: Romain BORDES, GÖTEBORG (SE); Kinga GRENDA, GÖTEBORG (SE)

(73) Assignee: ADSORBI AB, GÖTEBORG (SE)

(21) Appl. No.: 19/115,190

(22) PCT Filed: Sep. 29, 2023
(86) PCT No.: PCT/SE2023/050964

§ 371 Date: Mar. 25, 2025

(30) Foreign Application Priority Data
Oct. 3, 2022 (SE) 2251142-2

(51) Int. Cl. B01J 20/24; B01D 53/02; B01D 53/72

(52) U.S. Cl. CPC B01J 20/24; B01D 53/02; B01D 53/72; B01D 2239/02; B01D 2253/20; B01D 2253/25; B01D 2253/30; B01D 2257/708; B01D 2258/06

(57) ABSTRACT

A porous material for adsorbing gaseous pollutants, wherein the porous material is a solid dry porous material comprising a fibrous matrix of cellulose and inorganic carrier particles, and wherein an organic amine is attached to at least the inorganic carrier particles.

### FIELD OF THE INVENTION

The present disclosure relates to adsorbent materials. In particular it relates to chemisorbant materials for the adsorption of gaseous pollutants.

### BACKGROUND OF THE INVENTION

Unwanted air pollutants can cause unwanted effects in many areas, often negative effects on human health & wellbeing or cause damages to products & sensitive objects. Air pollutants in indoor environments can reach high concentrations and cause respiratory diseases, consequently, shortening life expectancy. Most air pollutants cause odours which in turn may result in mental health issues. In advanced wound applications, wounds will eventually give off a strong and unpleasant odour. The result is often that the patient suffers worsened mental health. Air pollutants can also damage products and sensitive objects of high value. This problem is also relevant within art conservation where air pollutants deteriorate works of art.

The air pollutants may be described as gaseous pollutants. An example of gaseous pollutants are volatile organic compounds, VOCs. VOCs are typically defined as any compound of carbon, excluding: carbon monoxide, carbon dioxide, carbonic acid, metallic carbides or carbonates; which participate in atmospheric photochemical reactions. An additional example of an air pollutant is ozone, O₃.

There are several adsorbent materials on the market where activated carbon is the dominant solution in air pollutant and odour removal. Other solutions consist of silica, zeolite, and metal organic frameworks. However, producers are becoming increasingly aware of the environmental burden of their products which has resulted in raw materials and carbon footprint being evaluated throughout the entire value chain. More efficient materials are needed to lower total environmental impact and lengthen the lifetime of products.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a porous material for adsorbing gaseous pollutants, wherein the porous material is a solid dry porous material comprising a fibrous matrix of fibrous cellulose and inorganic carrier particles, and wherein an organic amine is attached to at least the inorganic carrier particles.

The combination of cellulose, inorganic carrier particles and the organic amine result in a solid and compliant material having high chemisorption performance, is non- or low-toxic and non-leeching.

A method for adsorbing gaseous pollutants is also provided.

Articles comprising the porous material are provided.

A method for producing the porous material is provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description, reference being made to the accompanying drawings, in which

FIG. 1A is a microscope image of a granule prepared according to experiment 3 where a surfactant was used to form a foam having a reduced water content. The scale bar represents 200 μm.

FIG. 1B is a microscope image of a granule prepared according to experiment 3, without a surfactant used during the production. The scale bar represents 200 μm.

FIG. 2A is a graph of the chemisorption performance of granules prepared according to experiment 5 exposed to acetaldehyde.

FIG. 2B is a graph of the water absorption performance of granules prepared according to experiment 5.

### DETAILED DESCRIPTION

The porous material for adsorbing gaseous pollutants, such as volatile organic compounds, VOCs, comprises a fibrous matrix of inorganic carrier particles and cellulose. An organic amine is attached to at least the inorganic carrier particles. The cellulose based porous material has a high adsorption capacity, is biobased and non- or low-toxic on surface contact, and low density, enabling efficient and low environmental impact pollutant adsorption.

As described the porous material comprises a matrix of cellulose and inorganic carrier particles. The cellulose is fibrous cellulose. The fibrous cellulose results in the adsorbent material comprising a fibrous matrix of cellulose and inorganic carrier particles which has mechanical, and chemisorption advantages.

The cellulose may be cellulose nanofibers (CNF) having a high aspect ratio. The CNF may have a thickness of from about 5 nm to about 20 nm. The CNF may have a length in the range of hundreds of nanometres to several micrometres. The cellulose may be fibrous cellulose powder. The term fibrous cellulose powder as used herein refers to cellulose fibres in powdered form. The fibrous cellulose powder has cellulose fibres having a nominal average length of about 300 μm, that is, around two orders of magnitude greater than the length of CNF. Commercially obtainable fibrous cellulose powder will inherently comprise fibres of different lengths, however, the majority of the fibres should have an average length greater than about 100 μm. The cellulose fibres may have a thickness of about 20 μm. The cellulose may be sourced from a variety of known cellulose, or CNF sources. An example of a fibrous cellulose powder is Arbocel® BC 200 as used in the experiments below, however, other fibrous cellulose powders are suitable.

The cellulose forming the non-porous matrix is non-water soluble. The experimentation section details that replacing the cellulose with a water-soluble cellulose such as carboxymethyl cellulose (CMC) results in non-suitable materials. The cellulose for the porous material remains fibrous when mixed with water. The fibrous matrix formed by the fibrous cellulose and inorganic carrier particles is important for mechanical properties and forming the fibrous matrix. Additionally, the fibrous matrix absorbs any liquid produced during the chemisorption of VOCs by e.g., PEI. Additionally, CNF has been shown to provide both processing and dewatering advantages as the porous material maintains its structure during dewatering. A water-soluble cellulose derivative, such as CMC may be added as an additive, for example, at an amount of less than 10% dry weight of the final composition, however, the main cellulose content forming the porous matrix of the adsorbent material is water insoluble cellulose.

As the porous material is cellulose based, the porous material may comprise more than about 10% dry weight cellulose, such as CNF and/or fibrous cellulose powder. The porous material may comprise from about 10% dry weight cellulose to about 95% dry weight cellulose. The porous material may comprise more than about 50% dry weight cellulose, such as more than about 70% dry weight cellulose. The porous material may comprise a plurality of cellulose sources. For example, as shown in the experimentation section, the porous material may comprise powdered cellulose and CNF. If the porous material comprises cellulose in addition to CNF, then the CNF content may be less than 5% dry weight of the material. For example, the porous material may comprise fibrous cellulose powder at an amount from about 45% to about 94.9% and CNF at an amount from about 0.1% to about 5%. The combination of longer cellulose fibrous i.e., fibrous cellulose powder, and CNF results in a material having the ability to form pellets which are strong, possess good dewatering properties, and improved ability to absorb liquified VOCs.

The cellulose and the inorganic carrier particles form a matrix of cellulose fibres and inorganic carrier particles. The matrix is low density and has a high porosity such that the porous material may be considered a solid foam. The cellulose-inorganic particle matrix provides highly porous material through which gas may pass. That is, the porous material displays high gas permeability. High gas permeability enables both improved pollutant, such as VOC, adsorption capacity and additional uses of the material which would not be possible with a solid, less permeable material. A further advantage of the cellulose-based matrix is that the cellulose provides for a compliant solid porous material. The compliance of the solid porous material makes it especially suitable for various applications such as in packaging, in wound care articles, sanitary articles etc. where for example shock absorption and compliance is advantageous.

The porous material may be described as a low-density foam. The density of the porous material is less than 1 g/cm³. The density may be from about 0.01 g/cm³ to about 0.5 g/cm³. The density may be from about 0.05 g/cm³ to about 0.1 g/cm³, such as about 0.09 g/cm³.

The highly porous nature of the cellulose matrix enables the porous material to have improved insulation properties in comparison to other adsorbent material. Due to the pores the material, when in use, inherently comprises a large volume of air. The air is thermally insulting. In addition to this, the compliance of the material combined with the air in the pores results in improved sound insultation properties.

A packaging foam may comprise, such as consist essentially of, the porous material. As the material may be dried in moulds of various size and shape, the packaging foam may be shaped to fit around an article. For example, the packaging foam may be shaped as a solid rectangle comprising a recessed portion for receiving a receiving an artwork.

The adsorbent material may be incorporated into a polymer matrix or combined with other adsorbent matrices, provided that these matrices allow pollutant diffusion. Incorporation into a polymer matrix has been shown to improve adsorption of VOCs.

The inorganic carrier particles are inorganic particles providing a high surface area to which the organic amine may be attached. The inorganic carrier may be for example silica, clay, alumina. The inorganic carrier particle increases the rigidity of the porous material compared to an exclusively cellulose based matrix. The additional rigidity is especially advantageous to increase the usability of the material in various applications where a solid, yet compliant material is desirable. The inorganic carrier particles are selected and/or activated such that an organic amine may be attached to their surfaces. Ideally, the inorganic carrier particles are silica. As described in the experimental section, silica has been shown to form a solid porous matrix with cellulose. Silica is particularly advantageous when combined with cellulose in the adsorbent material as the combination silica and cellulose is thermally stable, and substantially heat resistant and fireproof. The fibrous matrix of silica and cellulose has been shown to char when subjected to sufficient heat, the charring forming an insulating layer thus limiting or restricting combustion of the material.

The porous material may comprise more than about 0.5% dry weight inorganic carrier particles. The porous material may comprise from about 1% to about 50% dry weight inorganic carrier particles. The porous material may comprise from 1% to 30% dry weight inorganic carrier particles. The porous material may comprise less than 40% dry weight inorganic carrier particles, such as less than 20% dry weight. The porous material may comprise cellulose and inorganic carrier particles at a ratio of from about 90:1 to about 1:1.

The organic amine is an organic molecule having at least one amine group. The organic amine has at least one alkane, alkene, alkyne, alkyl, or aryl group. Generally, the organic amine is a polyamine having multiple amine groups. The organic amine is preferably polyethylenimine (PEI). The organic amine, such as PEI, is attached to the surface of the inorganic carrier particles, such as silica particles. The organic amine may be attached to the cellulose present in the adsorbent material. PEI is especially suitable for chemisorption of VOCs.

It has been observed that on chemisorption of some VOCs, such as acetaldehyde, by PEI liquification may occur. That is, the PEI and VOC complex formed on adsorption undergoes liquification. The liquid formed may seep from a material and damage objects to which the material is in contact. Advantageously, the fibrous cellulose, and in particular the capillary structure of the fibrous cellulose matrix of the present porous material absorbs liquid formed after chemisorption of VOCs by PEI. The cellulose in the porous material thus absorbs liquid, and in particular liquified VOC-organic amine complexes.

Additionally, the porous material comprising PEI may undergo a colour change when exposed to VOCs. This function is provided by the PEI-inorganic carrier particle complex. Such a colour change enables the use of the porous material as an indicator of the presence of VOCs in an ambient environment.

Advantageously, the organic amine, such as PEI, provides an antibacterial and/or antimicrobial effect to the porous material. Such an antimicrobial effect is particularly advantageous in use as a wound care or personal hygiene article.

The organic amine, such as PEI, may be present in an amount of greater than 1%, such as from about 1% to about 50%. The organic amine may be present in an amount of from about 10% to about 30%, such as about 30%.

The porous material may comprise additional additives, agents selected to improve the properties of the porous material. The porous material may comprise a cross-linker to cross-link and fix the organic amine within the porous material. The cross-linker may form a chemically cross-linked organic amine, such as cross-linked polyethylenimine. The cross-linker may fix the organic amine to the inorganic carrier particles, may fix the organic amine to the cellulose, and may strengthen the cellulose. Ideally, a single cross-linking agent is selected which provides each of the above cross-linking functions. The cross-linker may be provided in an amount of from about 0.5% to about 5% vol, such as from 1% to 5% vol. to an aqueous solution comprising a mixture of PEI and inorganic carrier particles, or an aqueous solution comprising a mixture of PEI, inorganic carrier particles and cellulose.

As described in experiment 4, the porous adsorbent material may comprise graphene oxide. Graphene oxide has been shown to improve the adsorption of aromatic VOCs. The material may comprise graphene oxide at an amount of less than 10 wt. %, such as less than 1 wt. %. At amounts of over 1 wt. % the adsorbent material no longer undergoes a colour change when exposed to aldehydes and organic acids.

Where the concentrations in the above description are referred to as dry weight the concentration refers to the dry mass of porous material. As the material is substantially dehydrated during production the concentration of any components provided in a liquid medium may be determined based on their respective concentration in the liquid medium and the volume of liquid medium provided during production.

As described in the experimental section, the porous material is preferably formed via processing an aqueous suspension of the cellulose, inorganic carrier particles and organic amine. To promote the formation of the highly porous material the processing may comprise the step of adding a flocculant or a coagulant, and/or a cross-linker functioning as both a cross-linking agent to fix the organic amine to the cellulose and/or inorganic carrier particles, and as a wet-strengthening agent. As shown in experiment 3, the provision of a surfactant results in the formation of a dewatered foam being produced during the manufacturing process. During production, the dewatered foam may be separated from the aqueous suspension and then subsequently pelletised or granulated with additional cellulose fibres. As the foam has a reduced water content the duration and/or temperature subsequent drying step may be reduced resulting in reduced time of production and energy usage. The surfactant may be provided at an amount of from about 0.01 wt. % to about 5 wt. %, such as from about 1 wt. % to about 3 wt. %. Increasing the surfactant content has been shown to increase chemisorption performance, increase granule size when forming granules, and reduce granule density.

A method for producing the porous material comprises providing cellulose, such as dry CNF, to a solution to form a cellulose suspension in water. Adding a solution comprising an organic amine, such as PEI, to the cellulose suspension. Mixing the cellulose and organic amine to form a homogenous mixture of cellulose and organic amine. Adding inorganic carrier particles, such as silica, to the suspension. The mixture of cellulose, the inorganic carrier particles and organic amine may be in the form of a slurry, as shown in experiments 2 and 3, or have a greater liquid:solid ratio as shown in experiment 1. Advantageously, a surfactant is provided to the slurry, which is then processed to form the foam having a reduced water content as described above. As described in experiment 3, a surfactant flocculant is provided to the slurry, and the slurry is subsequently processed, such as whipped, such that a foam having a reduced water content is formed. Surfactants based on quaternary ammonium compounds, polymeric ester quaternary compounds, amphoteric surfactants or amine oxide-based compounds are suitable surfactants to form the foam having a reduced water content.

Additional cellulose in the form of fibrous cellulose powder may be added to the mixture which is then drum-rotated to form adsorbent granules during rotation. The resulting granules may be dried to form adsorbent granules for VOC adsorption. The drying process may be referred to as a dehydrating process. The dehydrating process ideally occurs above 0 °C. Ideally, the drying process is an oven drying process at an elevated temperature of greater than 25 °C, such as about 40 °C. The oven drying process of granules produced with the fibrous cellulose powder may have a duration of about 2 hours. Oven drying may also thermo-activate cross-linking agents present in the adsorbent material. The activation of cross-linking agents in the material may require a higher temperature of greater than about 65 °C, the activation step may occur during the oven drying, or as a step preceding the final oven drying step. The adsorbent material may be freeze dried, however, a freeze-drying process is energy intensive and oven drying is preferable. To enable effective oven drying without a preceding freeze-drying step, the material may be prepared as described in experiments 2 and 3, where a slurry of cellulose, inorganic carrier particles, and the organic amine is mixed with additional cellulose and drum rotated at an ideal solid:liquid ratio such that granules are formed which do not need freeze drying. The addition of fibrous cellulose powder also removes the need for centrifugation of the suspension of cellulose, organic amine, and inorganic carrier particles.

### Experimental Section

### Experiment 1—Preparation of Porous Adsorbent Material

The following describes a process for producing the porous adsorbent material.

10 g dry mass of cellulose nanofibers, CNF (Valida S231C, Sappi Maastricht BV), and 10 g dry mass of silica were added to a flask with magnetic stirring. 7.14 g dry mass of PEI in 10 ml of water having a total mass of 17.14 g were added to the receptacle under stirring. An additional 20 ml of water was added to the suspension in the receptacle. The mixture was covered and stirred. The reaction mixture was thereafter mixed in a reactor for about 2 hours.

To extract water from the mixture, the mixture was then centrifuged to separate the water from the cellulose, silica, and PEI sediment.

The centrifuged mixture was provided batchwise to a reactor and cooled. The formation of crystals was observed and once the grain size of the mixture has increased the reactor is stopped, and the mixture was poured into silicone moulds. The moulds were freeze dried under vacuum to form the solid foams. Optionally, the freeze-dried foams were baked in an oven at a temperature of from about 60 °C to about 80 °C for 24-48 hours.

### Experiment 1—Results Chemisorption Performance

The VOC chemisorption performance of the foams prepared with different concentrations of silica and PEI were compared to the VOC adsorption properties of other materials. The chemisorption performance was measured by placing a volume of the respective liquid in a chamber together with the porous material. The chamber was sealed at room-temperature for 29 days to achieve 100% saturation.

| | Acetic acid | Formic acid | Acetaldehyde | Formaldehyde | Water |
|---|---|---|---|---|---|
| | [G_{adsorbate}/ | [G_{adsorbate}/ | [G_{adsorbate}/ | [G_{adsorbate}/ | [G_{adsorbate}/ |
| | G_{adsorbent}] | G_{adsorbent} | G_{adsorbent}] | G_{adsorbent}] | G_{adsorbent}] |
| Activated Carbon | 0.43 | 0.56 | 0.42 | 0.42 | — |
| Bare silica | 0.43 | 0.73 | 0.31 | 0.19 | — |
| Cellulose foam | 0.23 | 0.88 | 0.07 | 0.24 | 0.12 |

Material comprising PEI:silica:cellulose
(final composition % dry weight)

| | | | | | |
|---|---|---|---|---|---|
| 30:56:44 | 3.25 | 5.90 | 34.09 | 0.94 | 0.39 |
| 10:72:18 | 1.00 | 2.73 | 11.93 | 0.36 | 0.24 |
| 30:35:35 | 2.01 | 3.13 | 23.06 | 0.79 | 0.23 |
| 10:45:45 | 0.85 | 2.04 | 8.62 | 0.32 | 0.18 |
| 30:17.5:52.5 | 1.76 | 3.13 | 13.25 | 0.55 | 0.21 |
| 10:22.5:67.5 | 0.57 | 1.51 | 6.15 | 0.33 | 0.15 |
| 30:7:63 | 1.66 | 2.59 | 14.37 | 0.55 | 0.25 |
| 10:9:81 | 0.66 | 1.49 | 5.46 | 0.22 | 0.13 |

Comparative examples (excluding either silica or PEI)

| | | | | | |
|---|---|---|---|---|---|
| 0:25:75 | 0.19 | 0.82 | 0.11 | 0.24 | 0.10 |
| 30:0:70 | 1.30 | 2.75 | 10.39 | 0.46 | 0.18 |
| 10:0:90 | 0.50 | 1.23 | 3.77 | 0.34 | 0.12 |

As can be seen, the performance of the foams comprising cellulose, PEI and silica was improved with respect to activated carbon, bare silica and cellulose alone. Compositions comprising more than 10 wt. % silica, and more than 10 wt. % PEI displayed improved adsorption performance. Compositions comprising more than 50 wt. % cellulose, such as from about 52.5 w % to about 67.5 wt. % displayed improved physical properties.

### Experiment 2—Preparation of Porous Adsorbent Granular Material Via Drum Rotation

The freeze-drying process described in Experiment 1 is both time and energy consuming. In order to develop a less energy and time intensive process a modified production process and material composition was prepared compared to experiment 1.

An aqueous slurry of cellulose fibres, inorganic carrier particles, and the organic amine was prepared. The cellulose fibres were CNF, the inorganic carrier particles were silica, the inorganic amine was PEI. The prepared slurry comprised 0.97 wt. % silica, 19.42 wt. % PEI, 1 wt. % CNF, and water. The slurry was mixed in a mechanical mixer. As opposed to experiment 1, no centrifugation step is required to separate the cellulose, silica, and PEI from the continuous medium.

The prepared slurry was added to a rotation drum. Fibrous cellulose powder (Arbocel® BC 200, J. Rettenmaier & Söhne GmbH+Co KG) or cellulose fibres from wood pulp were added to the slurry in the rotation drum such that the resulting mixture comprises the added fibrous cellulose powder or fibres from wood pulp (i.e., excluding CNF) at an amount of 79 dry wt. %. Optionally, water was added to the rotation drum depending on the desired solid:liquid ratio for testing. A wet strengthening agent was added to the rotation drum and thermo-activated at 65 °C to 105 °C for 5 min to 1 hr. The drum-rotated slurry was oven dried with air circulation and sieved to a desired fraction size. The solid:liquid ratio was found to control the size of the particles with an upper limit of about 1:5.5, which resulted in a paste and no granule formation. The optimal solid:liquid ratio was found to be about 1:3.

The granule size and density were also controllable via altering the rotation time, from 2 mins to 10 mins, with longer rotation durations resulting in larger sized granules having a higher density. The rotation speed of the drum rotator was found to control density, with higher rotor speeds leading to high density particles.

The particle size was also found to be controllable by adding additional silica during drum rotation. However, this led to reduced adsorption performance (see results).

### Experiment 2—Results Size and Chemisorption Performance

Granules prepared according to experiment 2 were found to have an improved overall hardness. The granules displayed a colour change when exposed to aldehydes and organic acids. The significant reduction in the amount of CNF led to reduced production costs. The granules absorb water and swell, but do not disintegrate. As stated above, freeze drying was avoided leading to reduced energy demands and production times via the process of experiment 2. Additionally, no centrifugation was required.

As stated above, the size of the granules produced with the process of experiment 2 was found to be controllable via the addition of silica during drum rotation.

| | % Size | % Size | % Size | % Size |
|---|---|---|---|---|
| | 0.5-0.7 | 1.0-1.5 | 1.8-2.5 | 3.0-6.0 |
| SiO₂ wt % | mm | mm | mm | mm |
| 1 (in slurry only) | 5 | 25 | 30 | 15 |
| 17 (added during | 13 | 25 | 15 | 16 |
| drum rotation) | | | | |

However, addition silica impregnation was found to decrease chemisorption performance from 35%-90% when tested with acetaldehyde.

The chemisorption performance of granules produced according to experiment 2, were tested in low air flow. As can be seen, there was a reduction in chemisorption performance for acetaldehyde, and formaldehyde for the particles produced according to experiment 2 compared to the material of experiment 1. This is hypothesised to be due to the lack of the freeze-drying step leading to particles of greater density and therein reduced surface area available for chemisorption. However, the chemisorption performance is remains acceptable for pollutant adsorption, and the reduction in process duration, reduction in process energy usage and reduction in material costs are significant benefits when producing granules according to experiment 2.

| | Particles prepared | Experiment 2 | Experiment 2 |
|---|---|---|---|
| | according to | Granules | Granules >2.8 |
| | Experiment 1 | 0.6-1 mm | mm |
| | [G_{adsorbate}/ | [G_{adsorbate}/ | [G_{adsorbate}/ |
| Adsorbate type | G_{adsorbent}] | G_{adsorbent}] | G_{adsorbent}] |
| Acetaldehyde | 35.12-21.97 | 2.55-3.67 | 3.45-3.79 |
| Formaldehyde | 1.27-1.48 | 0.35-0.71 | 0.39-0.63 |
| Toluene | 1.02-1-15 | 1.01-1.03 | 1.01-1.02 |
| Isopropanol | 1.01-1.49 | 0.97-1.12 | 1.01-1.69 |
| Acetone | 1.04-1.13 | 1.01-1.03 | 1.00-1.02 |
| H₂O at 100% | 0.97-1.25 | 0.25-0.48 | 0.21-0.39 |
| relative humidity | | | |
| H₂O at 55% | 0.18-0.73 | 0.07-0.12 | 0.03-0.09 |
| relative humidity | | | |

Granules produced with powdered cellulose and CNF were found to have improved performance compared to granules produced with birch pulp fibres.

| | Granules with | Granules with |
|---|---|---|
| | Arbocel | Birch pulp fibres |
| Adsorbate | [G_{adsorbate}/ | [G_{adsorbate}/ |
| type | G_{adsorbent}] | G_{adsorbent}] |
| Acetaldehyde | 1.18-4.25 | 1.40-2.46 |

### Experiment 3—Porous Adsorbent Material Produced with Surfactant

In an attempt to improve the chemisorption performance, and further reduce the time and energy demands of the production process, a modified process was developed which required less drying time. The slurry according to experiment 2 was prepared. The slurry was then whipped with a surfactant. Polymeric quaternary ammonium (Armohib CI-5150, Nouryon), amphoteric (Ampholak XCE, Nouryon) and amine oxide-based (Aromax 14D-W970, Nouryon) surfactants were each tested with satisfactory results. The surfactant was provided in an amount of from 0.013 wt. % to 2.6 wt. % with increasing surfactant resulting in increased granule sizes.

The whipped slurry was then provided to the rotator drum and the process of experiment 2 continued.

### Experiment 3—Results

By providing the slurry with a surfactant and subsequently whipping the slurry, a foam having a reduced water content is formed in the drum rotator. As the foam has a reduced water content, the duration of oven drying is reduced compared to the material produced according to experiment 2.

The chemisorption results are shown in the table below.

| | Acetaldehyde |
|---|---|
| Adsorbate type | [G_{adsorbate}/G_{adsorbent}] |
| Granules without surfactant | 2.20 |
| Granules with 0.013% surfactant | 1.05-2.79 |
| Granules with 0.13% surfactant | 1.44-2.86 |
| Granules with 2.6% surfactant | 2.28-3.25 |

It can be seen from the above table, that the chemisorption performance was maintained when the granules are produced according to the process of experiment 3. The introduction of a surfactant improved the manufacturing process and maintained or improved the chemisorption performance.

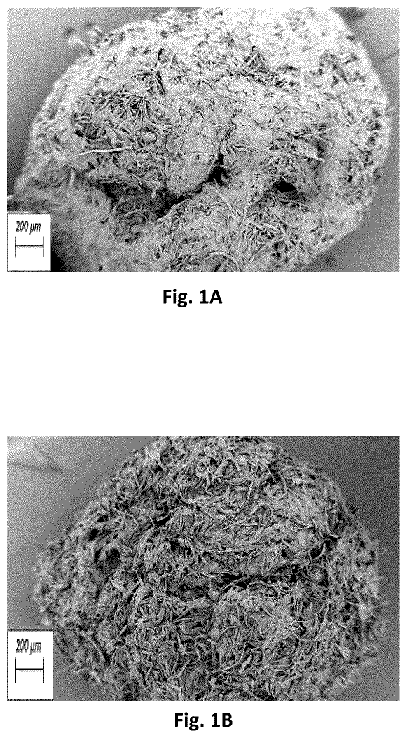

An image showing the granules produced with and without surfactants is shown in FIGS. 1A and 1B respectively. The porous adsorbent granular material produced according to experiment 3 was found to have increased porosity, i.e., lower density, and increased adsorption properties due to increased surface area. The granules also performed better in airflow due to the higher surface area. As with the material produced according to experiment 1 and 2, the material produced according to experiment 3 displayed good colour change characteristics when exposed to aldehydes and organic acids. As noted above, increasing the surfactant content resulted in larger granules.

### Experiment 4—Introduction of Graphene Oxide in Adsorbent Particles

The process according to experiment 1 was performed with the addition of graphene oxide (GOx). An amount of GOx was added to the mixture of water, CNF, PEI, and silica. Amounts of GOx from 0.1 wt. % to 10 wt. % were tested.

### Experiment 4—Results

The material with added GOx was found to be harder and less fragile. The adsorption performance of aromatic VOCs, such as toluene, was improved when GOx was added to the adsorbent material.

It was identified that when GOx was used in amounts of from 1 wt. % to 10 wt. % dewatering was improved, resulting in reduced drying process durations. However, at amounts of GOx greater than 1 wt. % the adsorbent material did not change colour when exposed to aldehydes and organic acids.

| | Particles without | Particles |
|---|---|---|
| | graphene | with graphene |
| | [G_{adsorbate}/ | [G_{adsorbate}/ |
| Adsorbate type | G_{adsorbent}] | G_{adsorbent}] |
| Acetaldehyde | 35.12-21.97 | 5.69-19.22 |
| Isopropanol | 1.01-1.49 | 1.09-1.38 |
| Toluene | 1.02-1.15 | 1.45-1.79 |
| H₂O at 100% | 0.97-1.25 | 1.01-1.28 |
| relative humidity | | |

### Experiment 5—Replacement of CNF or Cellulose Powder with Carboxymethyl Cellulose (CMC)

In order to determine if the cellulose fibres could be replaced with a water-soluble cellulose derivative such as carboxymethyl cellulose (CMC), adsorbent materials comprising CMC either partially, or fully replacing the fibrous cellulose were prepared.

The adsorbent material was prepared according to experiment 2. The CNF, fibrous cellulose powder or both CNF and fibrous cellulose powder content was replaced by CMC. Therefore, the amounts of CMC used were 0.5 wt. %, 71.1 wt. % and 71.6 wt. % respectively.

### Experiment 5—Results

Observations regarding the processing and the resulting the particles are detailed below.

| CMC content | | Acetaldehyde uptake | | H₂O uptake @ |
|---|---|---|---|---|
| (% dry wt.) | Observations | 72 h | 313 h | 55% RH (407 h) |
| 0 | | 2.316 | 3.368* | 1.039 |
| 0.5 | Sticky paste-like material. | 1.911 | 2.853* | 1.054 |
| | Big granules >1 cm. | | | |
| | Sticky, glue-like surface. | | | |
| 71.1 | No granulation. Yellow | 1.052 | 1.193 | 1.101 |
| | material after drying. Hard, | | | |
| | stiff material. Sticky. | | | |
| 71.6 | No granulation. Yellow, | 1.073 | 1.118 | 1.095 |
| | hard and stiff material. | | | |
| | Sticky. | | | |

*Saturation

As can be seen from above, replacing the fibrous water insoluble cellulose with a water-soluble cellulose derivative led to reduced processability, granulation was not observed at amounts of CMC over 0.5 wt. %. Such a cellulose derivative does not appear to be suitable to replace the fibrous cellulose of the present invention. Additionally, the sticky surface makes them not suitable for applications where the granules may contact delicate surfaces, such as artworks, or wound care products.

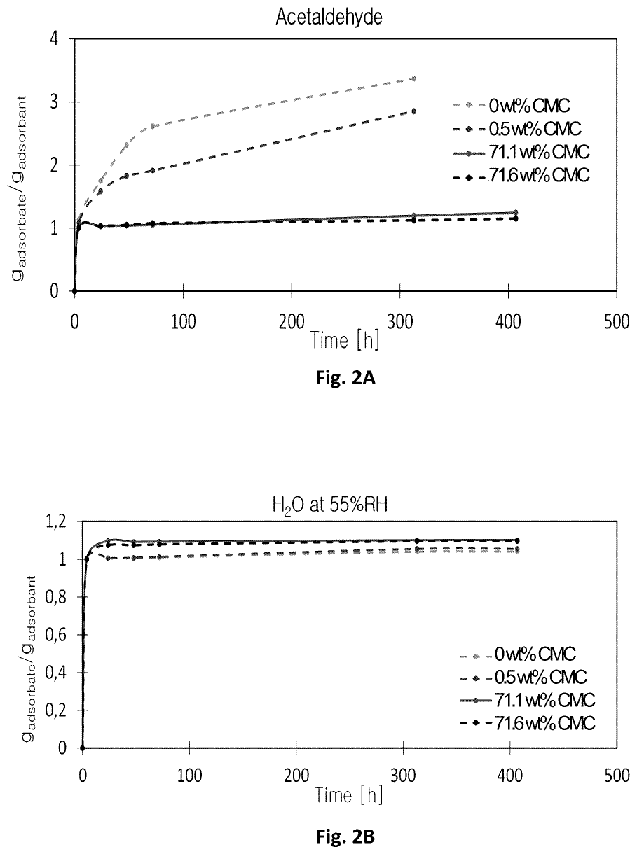

The chemisorption results over time are detailed in FIG. 2. In FIG. 2A, it can be seen that replacing the water insoluble cellulose fibres led to reduced chemisorption of acetaldehyde, compared to the material of experiment 2. In FIG. 2B it can be seen that replacing the water insoluble fibres led to reduced water uptake compared to the material of experiment 2.

In the above experiment results, ranges of adsorption performance are provided where different amounts of the various components provide different adsorption performance. For example, a greater amount of the organic amine in the material generally leads to improved chemisorption performance. Similarly, the amount of graphene oxide is correlated with the adsorption performance of aromatic VOCs.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality.

1-23. (canceled)

24. A porous material for adsorbing gaseous pollutants, wherein the porous material is a solid dry porous material comprising a fibrous matrix of fibrous cellulose and inorganic carrier particles, and wherein an organic amine is attached to at least the inorganic carrier particles.

25. The porous material according to claim 24, wherein the porous material comprises cellulose in an amount of at least 50 weight % based on the total dry weight of the material.

26. The porous material according to claim 25, wherein the porous material comprises cellulose in an amount of from about 50 weight % to about 90 weight % based on the total dry weight of the material.

27. The porous material according to claim 24, wherein the cellulose is water insoluble.

28. The porous material according to claim 24, wherein the fibrous cellulose comprises cellulose nanofibers, CNF, having an average fibre length of less than about 10 μm.

29. The porous material according to claim 24, wherein the fibrous cellulose comprises fibrous cellulose powder having an average fibre length of greater than about 100 μm.

30. The porous material according to claim 24, wherein the porous material has a density less than 1 g/cm³, such as from about 0.01 g/cm³ to about 0.5 g/cm³.

31. The porous material according to claim 24, wherein the organic amine is polyethylenimine.

32. The porous material according to claim 24, wherein the cellulose and the inorganic carrier particles are provided at a ratio of about between 90:1 to about 1:1.

33. The porous material according to claim 24, wherein the porous material comprises a cross-linking agent, wherein the cross-linking agent fixes the organic amine within the porous material.

34. The porous material according to claim 24, wherein the gaseous pollutants are volatile organic compounds, VOCs.

35. The porous material according to claim 24, wherein the porous material comprises a surfactant at an amount of from about 0.01 wt. % to about 3 wt. %.

36. A method for adsorbing gaseous pollutants, the method comprising:
providing a solid dry porous material comprising a fibrous matrix of cellulose and inorganic carrier particles, wherein an organic amine is attached to at least the inorganic carrier particles, and
submitting the porous material to an environment comprising at least one gaseous pollutant.

37. The method for adsorbing gaseous pollutants according to claim 36, wherein the porous material comprises cellulose in an amount of at least 50 weight %, such as from about 50 weight % to about 90 weight % weight based on the dry weight of the material.

38. A method for producing a porous material for adsorbing gaseous pollutants, the method comprising:
providing cellulose fibres, inorganic carrier particles and an organic amine to an aqueous solution to form an aqueous mixture of cellulose, inorganic carrier particles, and the organic amine,
dehydrating the mixture to form a solid porous material.

39. The method according to claim 38, wherein the cellulose is provided at an amount of such that the resulting solid porous material comprises at least 50 weight % cellulose based on the total dry weight of the material.

40. The method according to claim 38, wherein the method comprises:
forming a slurry of the aqueous mixture of cellulose fibres, inorganic carrier particles and the organic amine,
adding cellulose fibrous powder and optionally water, to the slurry,
processing the slurry and cellulose fibrous powder mixture, to form granules; and,
dehydrating the granules.

41. The method according to claim 40, wherein the method comprises:
adding a surfactant to the slurry at an amount of from about 0.01 wt % to about 3 wt. %; and,
whipping the slurry to create a foam having a reduced water content.

42. The method according to claim 41, where the dehydrating occurs at a temperature above 0 °C.

43. The porous material according to claim 24, wherein the porous material is provided in an air filter.
